(19) United States
(12) Patent Application Publication
(10) Pub. No.: US 2011/0317966 A1
(43) Pub. Date: Dec. 29, 2011

(54) SPLICED JOINT BETWEEN TWO OPTICAL FIBERS, AND METHOD FOR THE PRODUCTION OF SUCH A SPLICED JOINT

(75) Inventors: Malte Kumkar, Weimar (DE); Marcin Michal Kozak, Teltow (DE); Ulrich Grusemann, Gauting (DE)

(73) Assignee: JT OPTICAL ENGINE GMBH + CO. KG, Jena (DE)

(21) Appl. No.: 13/141,897

(22) PCT Filed: Dec. 18, 2009
(86) PCT No.: PCT/DE09/01788

§ 371 Date: Sep. 8, 2011

(30) Foreign Application Priority Data
Dec. 23, 2008 (DE) 102008062848.4

(51) Int. Cl. G02B 6/255; B29C 65/00

(52) U.S. Cl. 385/95; 156/166

(57) ABSTRACT

Disclosed is a spliced joint between two fibers, in which at least one of the fibers includes a fiber core comprising at least one inner signaling core and a pumping core that surrounds the signaling core, and a fiber cladding which rests against the pumping core and is used for guiding light within the pumping core. The fiber cladding of the at least one fiber is removed at least in part in a radial direction in a connection zone extending from the spliced end of the fiber along a predetermined length in the longitudinal direction of the fiber. Furthermore, a supporting jacket may be provided, inside which the spliced ends of the two fibers are arranged and which extends along the entire connection zone and therebeyond. The supporting jacket may be mechanically connected to both fibers next to the connection zone while not being mechanically connected to and being at a distance from the respective fiber along the entire connection zone.

The present invention relates to a spliced joint between two optical fibres, in which at least one of the fibres has a fibre core comprising at least one inner signal core and a pump core that surrounds the latter, and a fibre sheath, which lies against the pump core and serves to guide light in the pump core. Further, the present invention relates to a method for producing such a spliced joint.

When the fibres are designed to guide high optical power with high beam quality, there exists the difficulty of the increased sensitivity to bends, which can result, disadvantageously, for example, in the occurrence of increased losses for the light guided in the fibre core and/or in an unwanted coupling occurring between differing modes guided in the fibre core. Both result, disadvantageously, in an unwanted power loss for the desired mode.

In order to reduce the sensitivity to bending, it is known for the fibre sheath that serves to guide the light in the pump core to be realized so as to be relatively thick. In order that the fibre sheath has the desired guiding property, the fibre sheath can be produced, for example, from quartz glass and have a special doping profile in the region adjoining the pump core, such that the refractive index of this region is less than the refractive index of the pump core. Alternatively, it is also possible for the fibre sheath to be realized such that its inner diameter is greater than the outer diameter of the pump core, and for the fibre sheath to be connected to the pump core only via thin webs, such that between the fibre sheath and the pump core there exists, more or less, an air sheath that then ensures the desired guiding property. Such fibres are frequently also referred to as air-clad fibres.

When such fibres are spliced to each other, there occurs the difficulty that the input of heat required in this case disadvantageously alters the doping profile of the fibre sheath, or results in a collapsing of the fibre sheath, in such a way that, in the splice region, the fibre sheath is no longer separated from the pump core by webs. In both cases, the pump light guiding in the region of the splice is impaired considerably, as a result of which a high-quality splice is not possible in respect of the guiding property for pump light and signal light.

It is known from DE 35 30 963 A1, for the purpose of splicing two glass optical waveguides, to remove, in the region of the ends to be spliced, the original plastic sheaths that do not have a guiding function but that serve only to protect the glass optical waveguides, to splice the ends of the exposed glass optical waveguides, to dispose a small tube over the spliced ends, and to fill up the cavity between the small tube and the spliced ends with a hardenable lacquer.

If this method, known from DE 35 30 963 A1, were to be applied in the case of a spliced joint between two optical fibres, of which at least one has a fibre core comprising at least one inner signal core and a pump core that surrounds the latter, and a fibre sheath, which lies against the pump core and serves to guide light in the pump core, the guiding properties in the region of the spliced ends would be significantly impaired. In addition, the lacquer is not power-resistant, such that it would combust at high powers.

Proceeding therefrom, it is an object of the invention to provide a spliced joint between two fibres, in which at least one of the fibres has a fibre core comprising at least one inner signal core and a pump core that surrounds the latter, and a fibre sheath, which lies against the pump core and serves to guide light in the pump core, in which very good guiding properties for pump light and signal light can be ensured. Further, a corresponding method is to be provided for producing such a spliced joint.

The object is achieved, according to the invention, by a spliced joint between two optical fibres, in which at least one of the fibres has a fibre core comprising at least one inner signal core and a pump core that surrounds the latter, and a fibre sheath, which lies against the pump core and serves to guide light in the pump core, in which the fibre sheath of the at least one fibre is at least partially removed in the radial direction in a connection region that extends along a predetermined length from the spliced end of the fibre, in the longitudinal direction of the fibre, and in which a support sleeve is provided, in which the spliced ends of the two fibres are disposed and which extends along the entire connection region and therebeyond, wherein the support sleeve is mechanically connected to both fibres next to the connection region and, along the entire connection region, is at a distance from the respective fibre and not mechanically connected to the latter.

Owing to the support sleeve, the desired mechanical stabilization of the spliced joint is achieved, such that unwanted bending of the fibre cores can be prevented. Furthermore, the support sleeve serves as a contamination protection for the fibre cores. Since the support sleeve is not mechanically connected to the respective fibre along the entire connection region and is at a distance from this fibre, the guiding properties for light in the pump core are not disadvantageously impaired.

The support sleeve can be realized such that it has a desired minimum mechanical stiffness. The support sleeve thereby enables protection against kinking and bending to be realized for the spliced fibres.

The mechanical connection between the support sleeve and the fibres is preferably realized in a material-bonding and/or form-locking manner. This can be performed, in particular, through input of heat. In particular, laser radiation of a laser is used for this purpose.

The light guided in the pump core and/or signal core is, in particular, electromagnetic radiation of the visible spectrum (e.g. 380 nm to 780 nm) and of the adjoining infrared electromagnetic spectrum (780 nm to 2500 nm).

In particular, the fibre sheath is at least partially removed in the connection region, such that the guiding properties in respect of the pump light are as good as in regions in which the fibre sheath is not at least partially removed.

The support sleeve can have a substantially constant inner cross-section. Such a support sleeve, or such a support tube, can be produced very easily.

Further, the support sleeve can have a central region and two edge regions that adjoin the central region laterally, wherein the wall thickness of the central region is greater than that of the edge regions. As a result, advantageously, a small input of heat suffices in the mechanical connecting of the support sleeve to the fibres, since the mechanical connection can be performed in the edge regions.

Preferably, the central region extends over the entire connection region and somewhat therebeyond.

Further, in the case of the spliced joint according to the invention, the support sleeve can be mechanically connected to at least one of the two fibres via an intermediate sleeve. The provision of an intermediate sleeve makes it possible to adapt, for example, to differing fibre outer diameters of the two spliced fibres. The mechanical connection of the intermediate sleeve and fibre, on the one hand, and of the support sleeve and intermediate sleeve, on the other hand, can preferably be realized as a form-locking and/or material-bonding connection in each case. An input of heat, in particular, can be used to realize such a connection. In particular, laser radiation of a laser can be used for this purpose.

In particular, the fibre sheath of the at least one fibre can be completely removed in the connection region.

The support sleeve is preferably adapted, in respect of thermal expansion, to the material of the fibres. In particular, the support sleeve can be produced from the same material as the fibres (or fibre core and/or fibre sheath). Quartz glass can be used as the material. Each of the two fibres can be an active or a passive fibre.

The at least one fibre can be realized as a thick-sheath fibre. A thick-sheath fibre is understood here, in particular, as a fibre whose fibre sheath is at least of such thickness that micro-bending losses in normal environmental conditions become so small that no significant coupling-over from fundamental-mode light into higher modes of the fibre core occurs.

The support sleeve can be realized as a single piece.

Further provided is a method for producing a spliced joint between two fibres, wherein at least one of the fibres has a fibre core comprising at least one inner signal core and a pump core that surrounds the latter, and a fibre sheath, which lies against the pump core and serves to guide light in the pump core, in which the fibre sheath of the at least one fibre is at least partially removed in the radial direction in a connection region that extends along a predetermined length from the end of the fibre to be spliced, in the longitudinal direction of the fibre, a support sleeve is pushed over one of the two fibres, the two ends of the fibres to be spliced are aligned to each other and spliced to each other, the support sleeve is pushed over the spliced ends such that it extends along the entire connection region and therebeyond, the support sleeve is mechanically connected to both fibres next to the connection region and, along the entire connection region, in which it is at a distance from the respective fibre, is not mechanically connected to the latter.

By this method, it is possible to produce a spliced joint between two fibres that has excellent guiding properties, wherein at least one of the two fibres can be a thick-sheath fibre.

In particular, the fibre sheath of the at least one fibre can be completely removed in the connection region.

Further, in the case of the method according to the invention, an intermediate sleeve can be pushed over one of the two fibres before the splicing of the two ends, which intermediate sleeve is mechanically connected to one of the fibres, next to the connection region, after the splicing, wherein the support sleeve is mechanically connected to the intermediate sleeve.

The mechanical connection can be achieved, preferably, through input of heat.

It is understood that the features mentioned above and those yet to be explained in the following are applicable, not only in the stated combinations, but also in other combinations or singly, without departure from the scope of the present invention.

The invention is explained by way of example in yet greater detail in the following with reference to the attached drawings, which also disclose features essential to the invention. There are shown in:

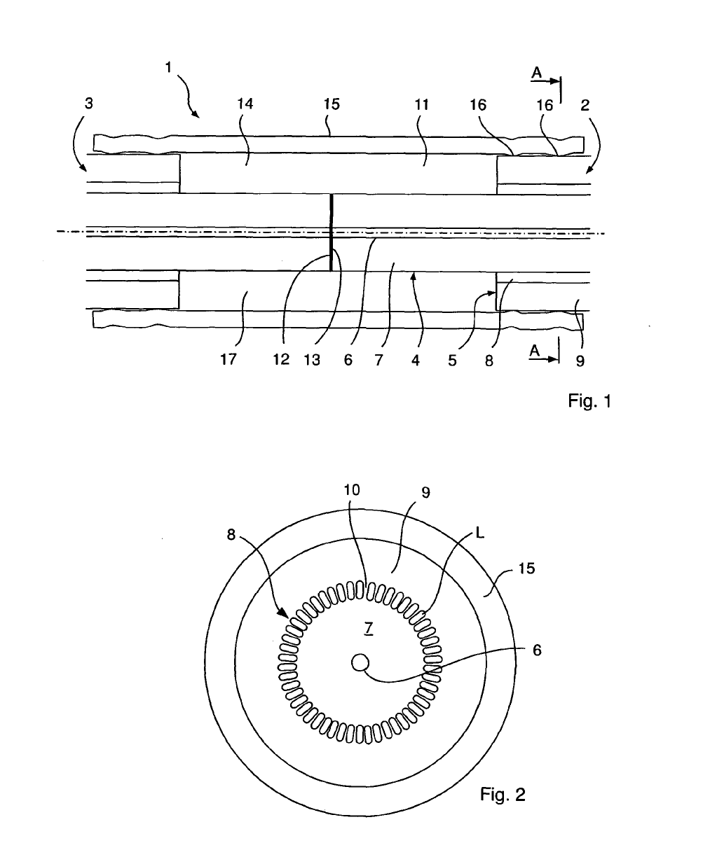

FIG. 1 a schematic sectional representation of a spliced joint according to the invention, according to a first embodiment;

FIG. 2 an enlarged sectional representation along A-A in FIG. 1;

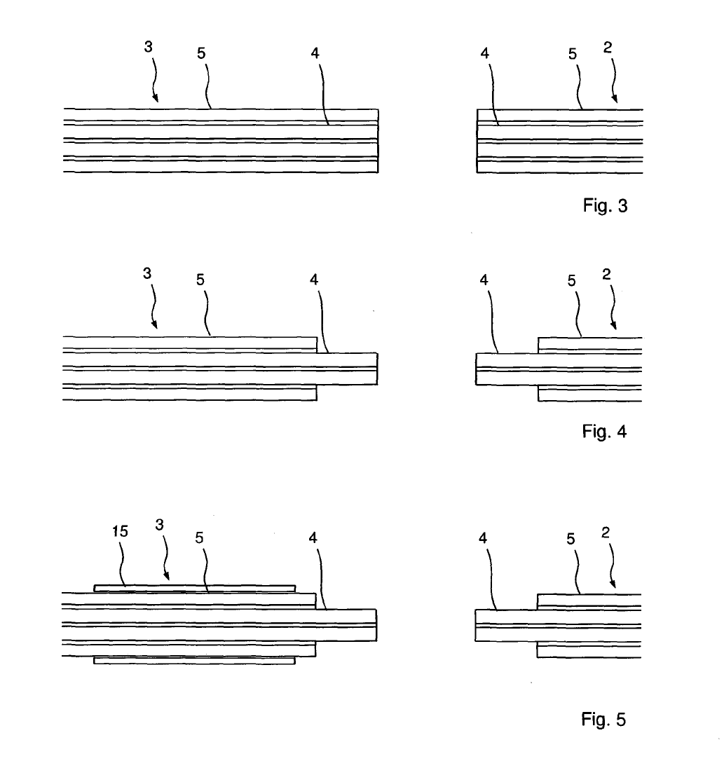

FIGS. 3-7 sectional representations to explain the production of the spliced joint of FIG. 1;

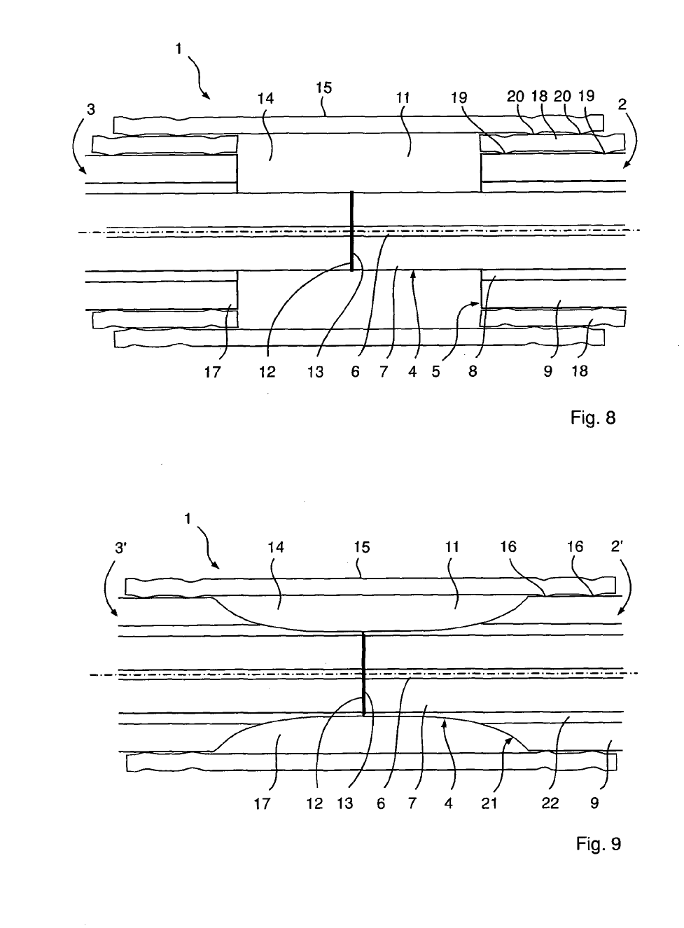

FIG. 8 a schematic sectional representation of a spliced joint according to a second embodiment;

FIG. 9 a schematic sectional representation of a spliced joint according to a third embodiment;

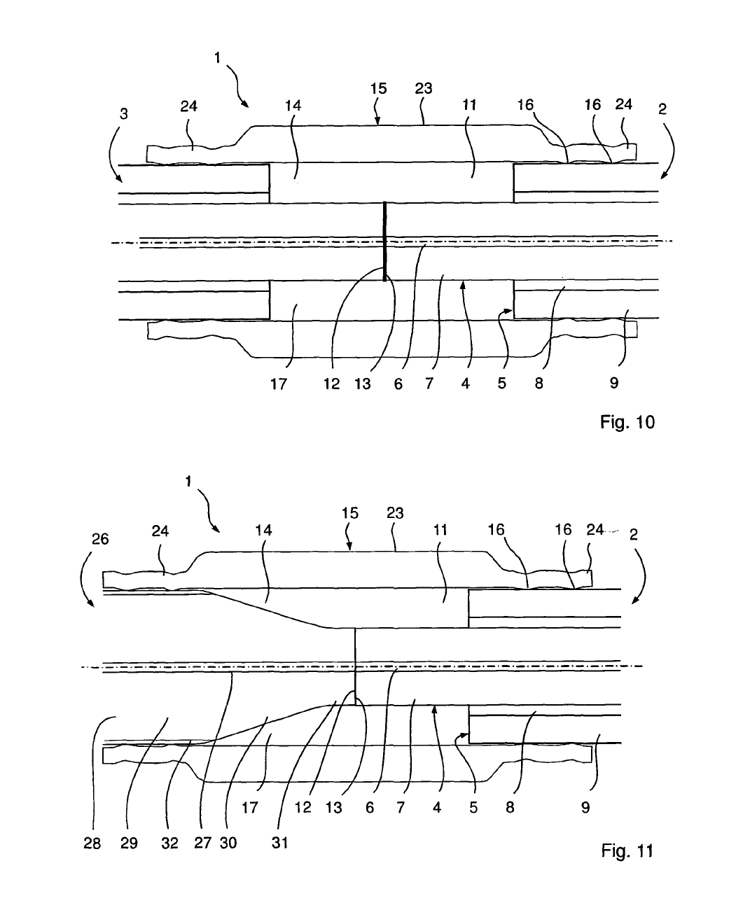

FIG. 10 a schematic sectional representation of a spliced joint according to a fourth embodiment; and

FIG. 11 a schematic sectional representation of a spliced joint according to a fifth embodiment.

In the case of the embodiment shown in FIG. 1, the spliced joint 1 according to the invention comprises a first and a second optical fibre, or optical waveguide, 2, 3, which are spliced to each other. Since the two fibres 2, 3 have the same structure, only the first fibre 2 is described in detail in the following. In the sectional representation of FIG. 1, as also in all further sectional representations, no hatchings are shown, in order to simplify the representation.

The first fibre 2 has a fibre core 4 and a fibre sheath or cladding 5 surrounding the fibre core 4. The fibre core 4 comprises an inner signal core 6, which is surrounded by a pump core 7. The fibre core 4 is composed of quartz glass, which is doped differently for the signal core 6 and the pump core 7, such that, owing to the resultant step in the refractive index between the signal core 6 and the pump core 7, the signal light can be guided in the signal core 6.

The fibre sheath 5 has an air sheath portion 8, which directly adjoins the pump core 7 and fully surrounds the pump core 7, and a main sheath portion 9 of quartz glass. As can be seen from FIG. 2, thin webs 10 of quartz glass pass axially through the air sheath portion 8. Via these webs 10, the main sheath portion 9 is mechanically and thermally connected to the pump core 7. Extending between the webs 10, in the longitudinal direction of the fibre 2, are air chambers L, which can be filled with air or with a gas. Owing to the described realization of the fibre sheath 5, the pump core 7 is more or less completely surrounded by an air sheath (air sheath portion 8) that is constituted by the air chambers L and ensures the guiding of the pump light in the pump core 7. Such a fibre 2 is frequently also referred to as an air-clad fibre.

The fibres 2, 3 have a total cross-section that is significantly greater than the cross-section of the fibre core 4, and can therefore also be referred to as thick-sheath fibres 2, 3.

The total diameter of the fibres can be, for example, in the range from 0.1-2.5 mm, and the diameter of the fibre core can be in the range from 50-800 μm. Preferably, the ratio of total cross-section to fibre-core cross-section is greater than 10:1 and, in particular, is in the range from 10:1 to 100:1. In order to enhance the clarity of the figures, the representation in FIG. 1 and in the further figures is not true to scale.

As can be seen from FIG. 1, the fibre sheath 5 is completely removed in a connection region 11, which extends along a predetermined length (here, approximately 10 mm) from the spliced end 12 of the first fibre 2, in the longitudinal direction of the first fibre 2, such that the pump core 7 is exposed in the connection region 11. Further, it can be seen from FIG. 1 that the second fibre 3 is constructed in the same manner as the first fibre 2 and, likewise, the pump core 6 is exposed over a predetermined length (second connection region 14), from the spliced end 13 of the second fibre.

The spliced joint 1 additionally comprises a support sleeve 15, produced from quartz glass, which extends over both connection regions 11 and 14 and therebeyond. The stiff, or rigid, support sleeve 15 has a wall thickness of approximately 30-200 μm and a substantially constant inner diameter, which is slightly greater than the outer diameter of the fibre sheath 5. As a result, the support sleeve 15 is at a distance from the fibres 2 and 3 along the two connection regions 11 and 14. Further, there is no mechanical connection of the support sleeve 15 to the exposed pump cores 7 of the fibres 2 and 3, such that the cavity 17 between the support sleeve 15 and the exposed pump cores 7 is filled with air or gas, and therefore serves as an air sheath for the exposed pump cores 7, in the same manner as the air sheath portions 8, such that the pump light continues to be guided in the connection regions 11 and 14. Alternatively, a vacuum can also be present in the cavity 17.

Outside the connection regions 11 and 14, at contact regions 16, the support sleeve 15 is fused to the fibre sheaths 5, and therefore mechanically connected thereto. The connection at the contact regions 16 is therefore material-bonding. As a result, the stiff support sleeve 15 serves as a protection against kinking for the exposed fibre cores 4, spliced to each other, which would not be protected against bending or kinking in the connection regions 11 and 14, owing to the removal of the fibre sheaths 5. Further, the support sleeve protects the exposed fibre cores and the air sheath portions 8 from contamination.

The removal of the fibre sheaths 5 provides the advantage that the fibre cores 4 can be satisfactorily spliced to each other, such that a high-quality splice is achieved in respect of the guiding property for pump light and signal light. A further advantage of removing the fibre sheaths 5 consists in the fact that the exposed fibre cores 4 can be more easily broken, in order to create, in each case, the end to be spliced. Polishing of the respective end to be spliced can also be performed in a satisfactory manner in the case of an exposed fibre core.

Were the two fibres 2 and 3 to be spliced to each other without the fibre sheath 5 being removed in the connection regions 11 and 14, the air sheath portion 8 would collapse, owing to the high input of heat during splicing, as a result of which the main sheath portion 9 would come into contact with the pump core 7, such that the guiding property for the pump core 7 would be lost in the region of the splice location. In addition, problems would occur in the guiding in the signal core.

This is not the case with the spliced joint 1 according to the invention, owing to the air-filled cavity 17 between the support sleeve 15 and the exposed pump cores 7 of the two fibres 2, 3, since, owing to the air-filled or gas-filled cavity 17, in which, alternatively, a vacuum can also be present, the guiding property for the pump light is retained.

The spliced joint according to the invention that is shown in FIG. 1 can be produced as follows. From the two ends of the fibres 2, 3 to be spliced (FIG. 3), which ends are each produced by, for example, breaking a fibre, the fibre sheath of the respective fibre 2, 3 is in each case removed along a predetermined length. This can be performed, for example, by cutting by means of a laser (e.g. femtosecond laser), by etching or by scoring and breaking.

If desired, the exposed fibre cores can each be broken, or cut off, again and polished, if appropriate, in order to produce an end to be spliced that has the desired properties. This can be performed, for example, by cutting by means of a laser (e.g. femtosecond laser), or by scoring and breaking.

After the fibre cores 4 have been exposed (FIG. 4), the support sleeve 15 is pushed over one of the two fibres 2, 3. In the case of the embodiment example described here, it is pushed over the second fibre 3 to such an extent that it does not extend over the exposed fibre core 4, but is located entirely in the region of the fibre sheath 5 that is still present (FIG. 5).

The ends of the two fibres 2, 3 to be spliced are thereupon polished or otherwise prepared, insofar as necessary. The support sleeve can also be pushed over the second fibre only after this step, or already before the fibre core is exposed.

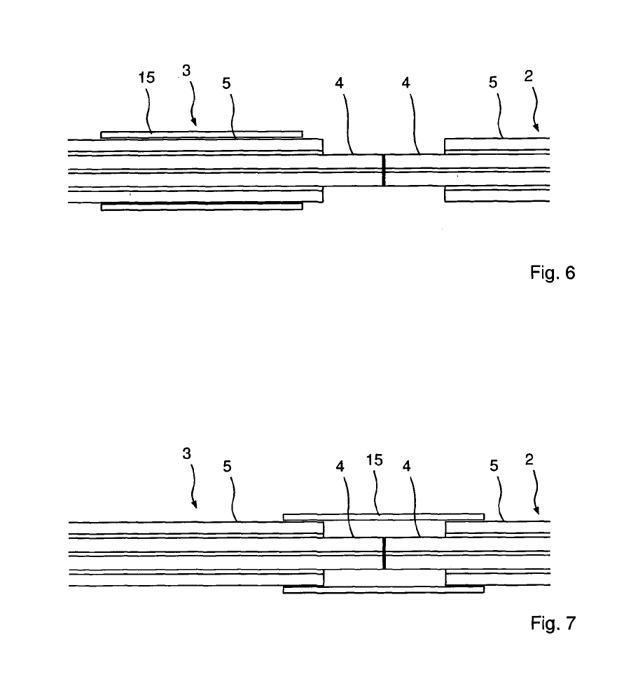

The two free ends of the fibre cores 4 are then aligned and spliced to each other in a known manner (FIG. 6).

After the splicing, the support sleeve 15 is pushed over the spliced ends such that it extends over the connection regions 11 and 14 on both sides and thus lies against the two fibre sheaths 5, next to the connection regions 11 and 14 (FIG. 7). In this state, the support sleeve 15 is then collapsed onto the fibre sheaths 5 in the contact regions 16, such that a mechanically fixed (material-bonding) connection is present and the spliced joint 1 according to FIG. 1 is produced. This collapsing is effected by a directed input of heat, e.g. by means of a laser.

Clearly, the fibre sheaths, in the usual manner, can have an outer plastic coating (not shown). This plastic coating is preferably removed to such an extent that the support sleeve 15 can be displaced on the fibre sheaths 5 in the manner described and mechanically connected to the latter. After the mechanical connection of the support sleeve 15 and fibre sheaths 5, the plastic coating can be re-applied in the region of the support sleeve 15.

Shown in FIG. 8 is a second embodiment of the spliced joint 1 according to the invention, which differs from the embodiment according to FIG. 1 in that an intermediate sleeve 18 is disposed between the support sleeve 15 and each of the fibre sheaths 5. The intermediate sleeves 18 are connected to the fibre sheaths 5 in a mechanically fixed manner over contact regions 19. The support sleeve 15, again, is fixedly connected to the intermediate sleeves 18 over contact regions 20. The intermediate sleeves 18 allow adaptation to fibre sheaths of differing thicknesses, or to fibres 2, 3 of differing thicknesses. This also enables the support sleeve to be pushed over a (not represented) coating (or outer coating, e.g. a polymer coating) (outside and, for example, adjoining one of the connection regions 11, 14).

During production, in a step according to FIG. 5, the intermediate sleeves 18 are first pushed onto both fibres. The support sleeve 15 is then pushed onto one of the two fibres. After splicing of the fibre ends, the intermediate sleeves 18 are mechanically connected to the fibre sheaths, and the support sleeve 15 is then connected to the intermediate sleeves 18.

A further embodiment of the spliced joint 1 according to the invention is shown in FIG. 9. In this embodiment, the spliced fibres 2′ and 3′ are again realized in the same manner, but differ from fibres 2, 3 shown in FIGS. 1 and 8 in the realization of the fibre sheath.

The fibre sheath 21 of the fibre 2′ includes a guide region 22, which lies directly against the pump core 7 and has a lower refractive index than the pump core 7. The guide region 22 can be produced from doped quartz or, also, from non-doped quartz. In order to retain the guiding of the pump light, the fibre sheath 21 is only partially removed (e.g. by etching) in the connection region 11, 14, such that there is still always at least a part of the guide region 22 lying against the pump core 7. Because of the significantly lesser thickness of the remaining fibre sheath 21 that is then present in the region of the ends to be spliced, in comparison with the fibre sheath 21 outside the connection regions 11, 14, the input of heat for the production of the spliced joint can be minimized, such that the possible influencing of the doping profile in the guide region 22 can be minimized. The guiding property is thereby also retained in the region of the spliced joint. Owing to the support sleeve 15, the desired necessary stability against bending and kinking of the spliced fibres is achieved in the region of the spliced joint.

In a modification of the embodiment of FIG. 9, the fibre sheaths 21 of the fibres 2′ and 3′ can also be completely removed in the connection regions 11 and 14. In this case, the guiding property in the connection regions 11 and 14 is then ensured by the air layer present, in the same manner as in the case of the spliced joint of FIG. 1 or 8.

A modification of the spliced joint according to the invention of FIG. 1 is shown in FIG. 10, wherein the only difference lies in the realization of the support sleeve 15. The support sleeve 15 continues to have a substantially constant inner cross-section. In a central region 23 of the support sleeve 15, however, the wall thickness is greater than in its edge regions 24, 25. In this case, the extent of the central region 23 in the axial direction is preferably selected such that the central region 23 extends over the fibre sheaths 5. The mechanical connection between the support sleeve 15 and the fibre sheaths 5 is then effected in the edge regions 24 and 25. This results in the advantage that, owing to the lesser wall thickness of the edge regions 24, 25, a small input of heat is required to produce this mechanical connection, and an increased stability can be provided by the greater wall thickness in the central region 23.

The spliced joint 1 according to the invention is not limited to the splicing of two fibres, or optical waveguides, that are realized in the same manner. Thus, for example, differing outer diameters of the fibres 2, 3 to be spliced can be compensated by means of the intermediate sleeves 18 according to FIG. 8.

Shown in FIG. 11 is an embodiment example in which a first fibre 2, as has been described, for example, in FIG. 1, is spliced to a second fibre 26 that tapers towards its spliced end. The second fibre 26 can serve, for example, as a coupling-in fibre, wherein it has a signal core 27 that has a constant cross-section, and a tapering pump core 28. The pump core 28 in this case is realized such that it comprises a first portion 29 having a large outer diameter, a second, tapering portion 30 that adjoins the latter, and a third portion 31, which adjoins the latter and whose free end is spliced to the end of the first fibre 2. For the purpose of guiding the pump light, the first portion 30 can have a doping region 32, located radially outwards.

The taper is realized such that pump light is coupled as well as possible (in particular, to the best extent possible) out of the second fibre 26 into the fibre core of the first fibre 2.

In the case of the embodiment of FIG. 11, the support sleeve 15 is realized in the same manner as in the case of the embodiment of FIG. 9.

1-11. (canceled)

12. A spliced joint between two fibres, comprising:
A first fibre and a second fibre, wherein at least one of the first and second fibres includes a fibre core comprising at least one inner signal core and a pump core that surrounds the latter, and a fibre sheath, which lies against the pump core and serves to guide light in the pump core, wherein the fibre sheath of the at least one of the first and second fibres is at least partially removed in a radial direction in a connection region that extends along a predetermined length from the spliced end of the fibre, in the longitudinal direction of the fibre; and
a support sleeve in which the spliced ends of the two fibres are disposed and which extends along the entire connection region and therebeyond, wherein the support sleeve is mechanically connected to both of the first and second fibres next to the connection region and, along the entire connection region, is not mechanically connected to the respective fibre and is at a distance from the latter.

13. A spliced joint according to claim 12, in which the support sleeve has a substantially constant inner cross-section.

14. A spliced joint according to claim 13, in which the support sleeve includes a central region and two edge regions that adjoin the central regional laterally, wherein the central region has a wall thickness greater than a wall thickness defined by the edge regions.

15. A spliced joint according to claim 12, in which the support sleeve includes a central region and two edge regions that adjoin the central regional laterally, wherein the central region has a wall thickness greater than a wall thickness defined by the edge regions.

16. A spliced joint according to claim 12, in which the support sleeve is mechanically connected to at least one of the first and second fibres via an intermediate sleeve.

17. A spliced joint according to claim 12, in which the fibre sheath of the at least one fibre is completely removed in the connection region.

18. A spliced joint according to claim 12, in which at least one of the first and second fibres tapers within the support sleeve.

19. A spliced joint according to claim 12 in which the both of the first and second fibres are configured in the same manner.

20. A spliced joint according to claim 12, in which the support sleeve comprises a single piece.

21. A method for producing a spliced joint between first and second fibres, wherein at least one of the first and second fibres includes a fibre core comprising at least one inner signal core and a pump core that surrounds the latter, and a fibre sheath, which lies against the pump core and serves to guide light in the pump core, the method comprising:
at least partially removing the fibre sheath from the at least one fibre in the radial direction in a connection region that extends along a predetermined length from the end of the fibre to be spliced, in the longitudinal direction of the fibre;
pushing a support sleeve over one of the first and second fibres;
aligning and splicing together a first fibre end of the first fibre and a second fibre end of the second fibre;
pushing the support sleeve over the spliced ends such that it extends along the entire connection region and therebeyond;
mechanically connecting the support sleeve to both first and second fibres next to the connection region and, along the entire connection region, in which it is at a distance from the respective fibre, is not mechanically connected to the latter.

22. A method according to claim 21, wherein the fibre sheath of the at least one fibre is completely removed in the connection region.

23. A method according to claim 22, wherein an intermediate sleeve is pushed over one of the first or second fibres before the splicing of the two ends, which intermediate sleeve is mechanically connected to one of the fibres, next to the connection region, after the splicing, and the support sleeve is mechanically connected to the intermediate sleeve.

24. Method according to claim 21, wherein an intermediate sleeve is pushed over one of the first or second fibres before the splicing of the two ends, which intermediate sleeve is mechanically connected to one of the fibres, next to the connection region, after the splicing, and the support sleeve is mechanically connected to the intermediate sleeve.
